(19) United States
(12) Patent Application Publication
(10) Pub. No.: US 2009/0237843 A1
(43) Pub. Date: Sep. 24, 2009

(54) MAGNETIC HEAD ASSEMBLY AND STORAGE APPARATUS

(75) Inventor: Kazushige Miura, Higashine (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki (JP)

(21) Appl. No.: 12/409,541

(22) Filed: Mar. 24, 2009

(30) Foreign Application Priority Data
Mar. 24, 2008 (JP) 2008-76683

(51) Int. Cl. G11B 21/24

(52) U.S. Cl. 360/294; G9B/21.028

(57) ABSTRACT

An aspect of the embodiments relates to a magnetic head assembly. The magnetic head assembly includes a suspension comprising an attachment surface, a bent section that extends generally vertically from the attachment surface, and a suspension comprising a first plurality of terminals attached on the bent section; and a head slider comprising a tracking surface, a fixed surface provided on an opposite side of the tracking surface, a lateral side that extends generally perpendicularly between the fixed surface and the tracking surface, and a second plurality of terminals attached on the lateral side, wherein the first plurality of terminals is opposed and connected electrically to the correspondent second plurality of terminals, with the fixed surface of the head slider fixed onto the attachment surface of the suspension.

### CROSS-REFERENCE TO RELATED APPLICATIONS

This application is based upon and claims the benefit of priority of the prior Japanese Patent Application No. 2008-76683, filed on Mar. 24, 2008, the entire contents of which are incorporated herein by reference.

### FIELD

The embodiments discussed herein are directed to a magnetic head assembly and a storage apparatus. More specifically, the present invention relates to a magnetic head assembly having terminals attached on one of the surfaces thereof excluding a surface with which the magnetic head is attached onto a suspension, and to the storage apparatus having the magnetic head assembly.

### BACKGROUND

Storage apparatuses such as magnetic disk apparatuses have magnetic head assemblies. The magnetic head assembly has a suspension, and the suspension has a magnetic head on its tip. The suspension is provided with wires and each a first end of each wires connects with a signal processor and a second end of each wires connects with one of a plurality of terminals. The magnetic head is attached on a head slider having a tracking surface, or an air bearing surface (ABS), that flies over a recording surface of a magnetic disk in reading and writing signals and a fixed surface formed on the opposite side of the ABS, with which the head slider is fixed to the suspension. On one of the surfaces of the head slider excluding the ABS and the fixed surface, a plurality of terminals are attached that connect with terminals attached on the suspension electrically.

FIG. 1 is a side view illustrating a portion of a conventional magnetic head assembly. As illustrated in FIG. 1, the magnetic head assembly has a head slider 1 and a suspension 2. The head slider 1 has an ABS 11, a fixed surface 12 and a lateral side 13. On the lateral side 13, a plurality of terminals 14 are attached. The fixed surface 12 of the head slider 1 is attached onto an upper surface, or an attachment surface, of the suspension 2 with, for example, adhesive 3. Each of a plurality of terminals 24 attached onto the upper surface of the suspension 2 connects with a correspondent terminal 14 attached on the head slider 1 with solder.

With downsizing of the magnetic disk apparatuses, the magnetic head assemblies are miniaturized. As the magnetic head assemblies become smaller, the terminals attached on the head sliders and the suspensions become miniscule. There has been a technique for controlling a flying height of the magnetic head from a magnetic disk by controlling a heater embedded in the magnetic head to deal with the increasing recording density. For the magnetic head having the heaters, the terminals attached onto the head slider and the suspension are increased by an amount equal to the number of the heaters. Consequently, the terminals become more and more minuscule due to the decrease of the terminals in size and the increase of the terminals in quantity.

The technique to attach the head slider onto the attachment surface of the suspension with solder and to connect the terminals with solder electrically has been disclosed in patent literature 1 (Japanese Unexamined Patent Application Publication No. S63-113918). The technique to circumvent constraints on a rotational movement of the head slider has been proposed in patent literature 2 (Japanese Unexamined Patent Application Publication No. H8-31127).

Conventionally, an exposed area of the solder applied for connecting the terminals on the head slider with the terminals on the suspension electrically is relatively large, which increases a probability of the solder chip off.

### SUMMARY

An an aspect of embodiments of the present invention is to provide a magnetic head assembly and a storage apparatus to reduce if not prevent the conductive material materials such as solder for connecting the terminals attached on the head slider with the terminals attached on the suspension electrically from chipping off.

In accordance with an aspect of embodiments, a magnetic head assembly, includes a suspension comprising an attachment surface, a bent section that extends generally vertically from the attachment surface and a suspension comprising a first plurality of terminals attached on the bent section and a head slider comprising a tracking surface, a fixed surface provided on an opposite side of the tracking surface, a lateral side that extends generally perpendicularly from the fixed surface and connects the tracking surface with the fixed surface, and a second plurality of terminals attached on the lateral side, wherein the first plurality of terminals is opposed and connected electrically to the correspondent second plurality of terminals, with the fixed surface of the head slider fixed onto the attachment surface of the suspension.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is a side view illustrating a portion of the conventional magnetic head assembly;

FIGS. 2A through 2D are the photomicrographs depicting a portion of the exposed area of the solder that connects a pair of the terminals;

FIGS. 3A and 3B are the photomicrographs depicting the adherent matter attached on the head slider incorporated in a failed magnetic disk apparatus;

FIG. 4 is a plane view of the magnetic disk apparatus;

FIGS. 5A and 5B illustrate the magnetic head assembly;

FIGS. 6A and 6B illustrate the HGA;

FIGS. 7A and 7B illustrate the attachment surface of the head slider;

FIGS. 8A through 8C illustrate the head slider from three angles;

FIG. 9 is a side view of a portion of the magnetic head assembly according to the first embodiment of the present invention;

FIG. 10 is a side view illustrating a portion of the magnetic head assembly according to the second embodiment of the present invention;

FIG. 11 is a side view illustrating a portion of the magnetic head assembly according to the third embodiment of the present invention; and

FIG. 12 is a side view illustrating a portion of the magnetic head assembly according to the fourth embodiment of the present invention.

### DETAILED DESCRIPTION OF THE EMBODIMENTS

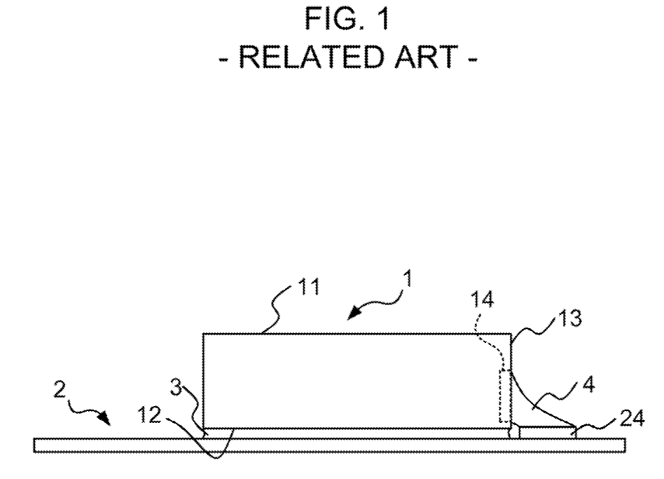

For the magnetic head assembly illustrated in FIG. 1, the terminals 14 are conventionally connected with the terminals 24 by gold ball bonding (GBB) using solder that is made of gold, Au. However, the miniaturization of the magnetic head assembly and the increase of terminals 14 and 24 in quantity make applying GBB difficult. Thus, solder ball bonding (SBB) is applied instead. For SBB, the solder is made of Pb-free materials in consideration of the effect on the environment. However, the Pb-free solder, in comparison with lead based solder, has lower solderability. Moreover, for the conventional magnetic head assembly, the contact angle of the surfaces on which the terminals 14 and 24 are attached is large, in this case, a substantially a right angle. Therefore, relatively a large amount of the solder is applied thereto, and proportionally the exposed area of the solder is relatively large.

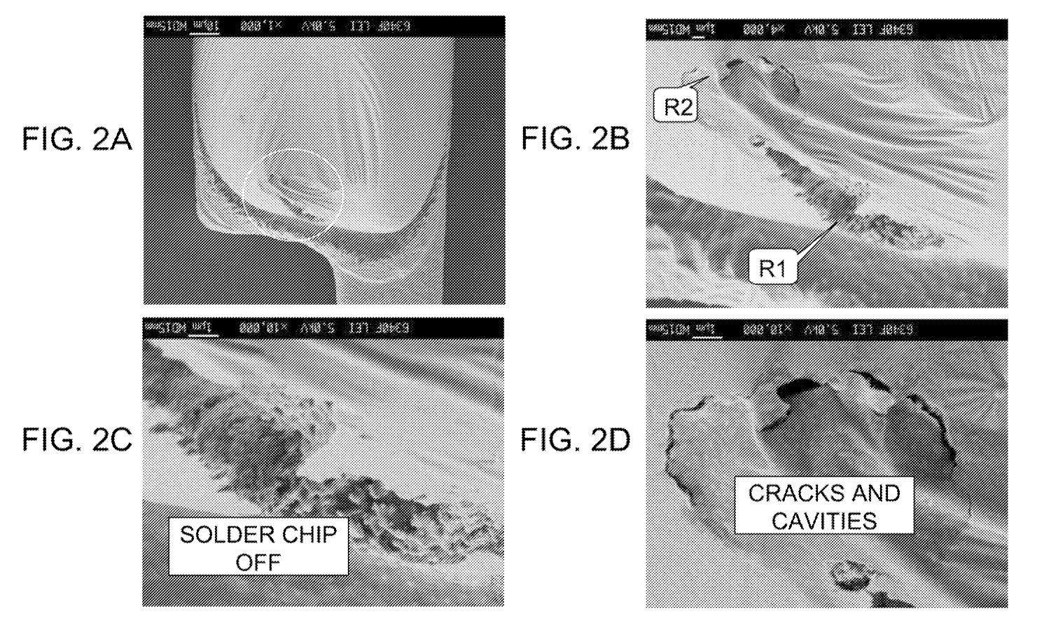

The inventors of this invention have found this problem is significant in terms of impacts on performance and reliability of the magnetic disk apparatuses. In FIG. 2, photomicrographs depict a portion of the exposed area of the solder 4 connecting a pair of the terminals 14 with 24 illustrated in FIG. 1. In FIG. 2A, the chipped portion of the solder 4 is circled with a white line. FIG. 2B is an enlarged image of the circled area illustrated in FIG. 2A. FIG. 2C is an enlarged image of the area labeled as R1 in FIG. 2B. FIG. 2D is an enlarged image of the area labeled as R2 in FIG. 2B. The chip off of the solder 4 is observed in FIG. 2C. Cracks and cavities are observed in FIG. 2D. The chip off of the solder 4 may be caused by a stress applied thereto, etc.

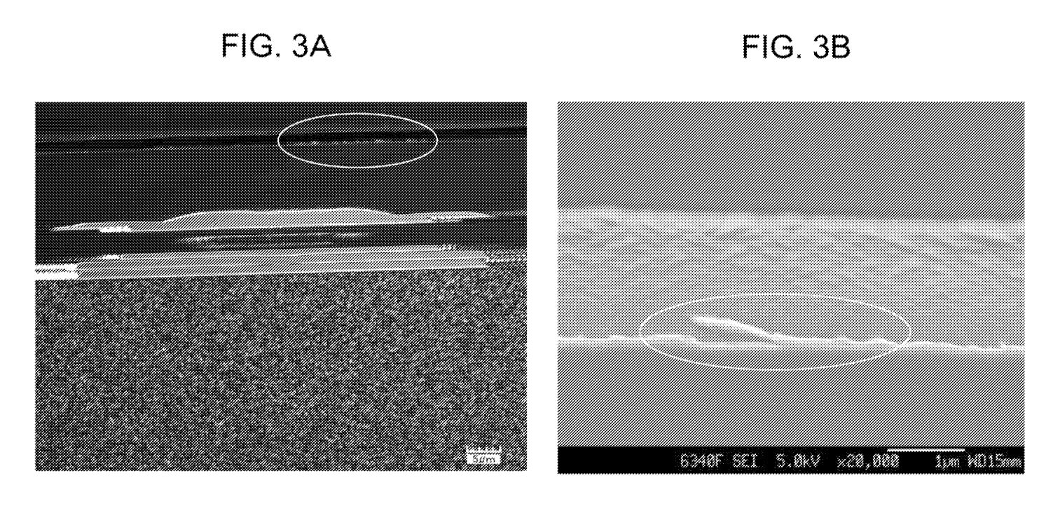

FIG. 3 is photomicrographs depicting an adherent matter attached on a head slider incorporated in a magnetic disk apparatus that had a failure such as head disk interference (HDI). In FIG. 3A, a head element on which the adherent matter is attached is circled with a white line. FIG. 3B is an enlarged image of the circled area depicted in FIG. 3A. An analysis of the adherent matter indicates that the adherent matter contains the same content of Sn that is contained in the solder 4. In many cases, Sn is detected in the adherent matters attached to the head elements incorporated in the failed magnetic disk apparatuses. One of the possible factors is that relatively a large amount of the solder 4 chips off where the solder 4 is exposed in a relatively large area. This suggests that the solder chipped off where the exposed area is large adheres onto the ABS 11 of the head slider 1, causing the failures such as HDI of the magnetic disk apparatus at a considerable level.

In the embodiments disclosed hereinafter, storage apparatuses shall refer to magnetic disk apparatuses using magnetic disks as magnetic storage mediums for the ease of description.

### Embodiment 1

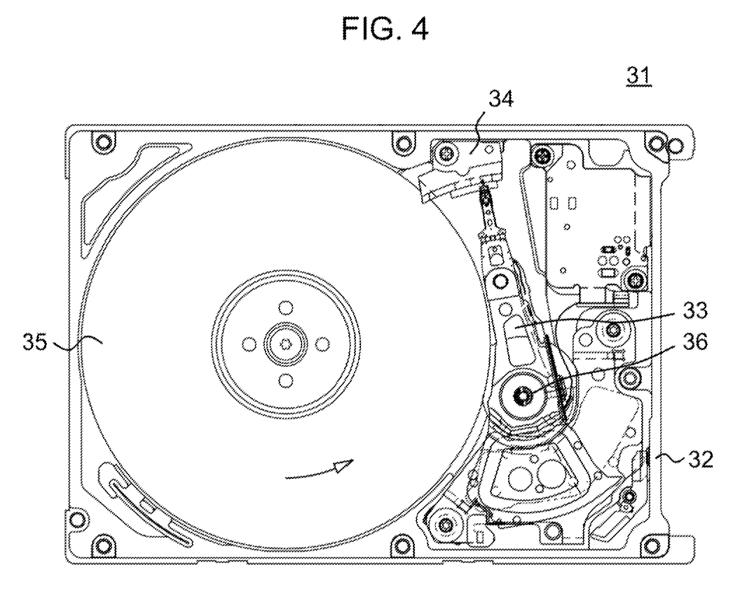

FIG. 4 is the plane view of the magnetic disk apparatus. The basic structure of the magnetic disk apparatus is common through all embodiments disclosed hereinafter. The structure of the magnetic disk apparatus illustrated in FIG. 4 is a well-known structure, and the other well-known structures are also applicable.

A magnetic disk apparatus 31 illustrated in FIG. 4 has a base 32, a magnetic head assembly (or a head stack assembly (HSA)) 33, a load-unload mechanism 34, and a magnetic disk 35, etc. The magnetic head assembly 33 rotates around a pivot 36.

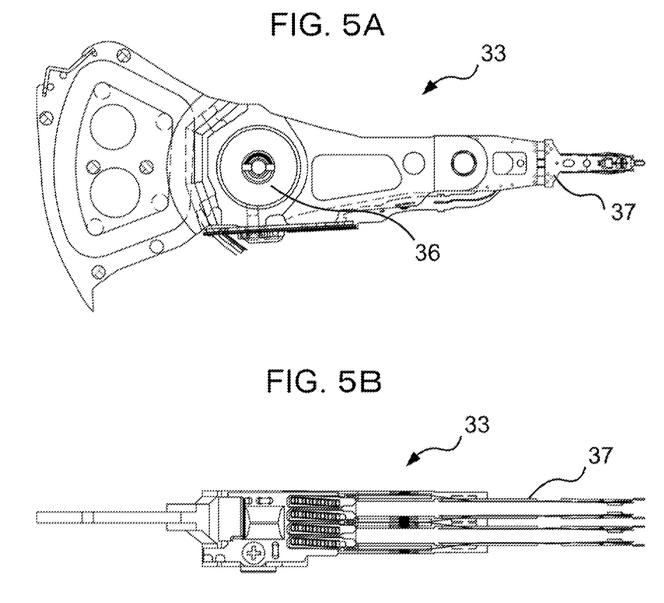

FIG. 5 illustrates the magnetic head assembly 33. FIG. 5A is a plane view of the magnetic head assembly 33. FIG. 5B is a side view of the magnetic head assembly 33. The magnetic head assembly 33 illustrated in FIG. 5 has a head gimbal assembly (HGA) 37.

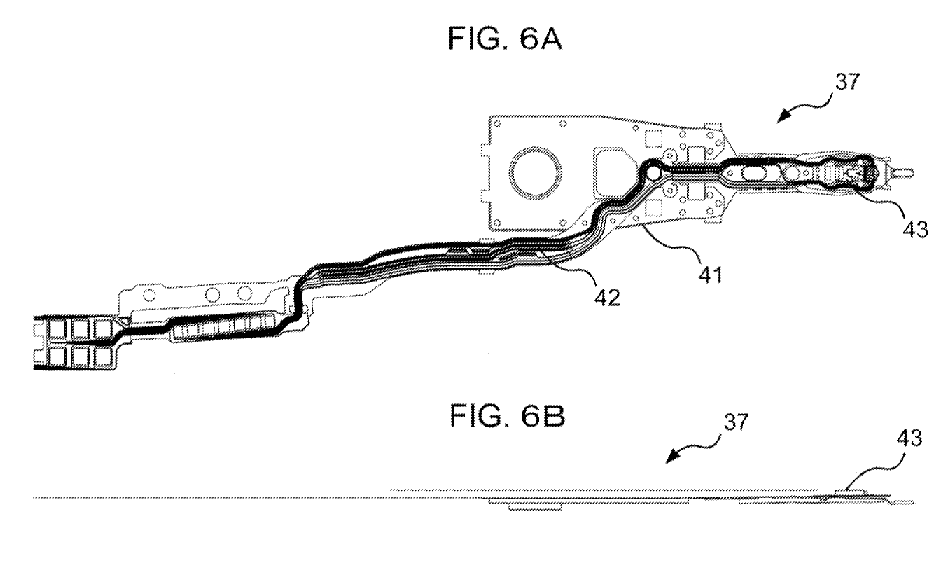

FIG. 6 illustrates the HGA 37. FIG. 6A is a plane view of the HGA 37. FIG. 6B is a side view of the HGA 37. The HGA 37 illustrated in FIG. 6 has a suspension 41. The suspension 41 has wires 42 and a head slider 43.

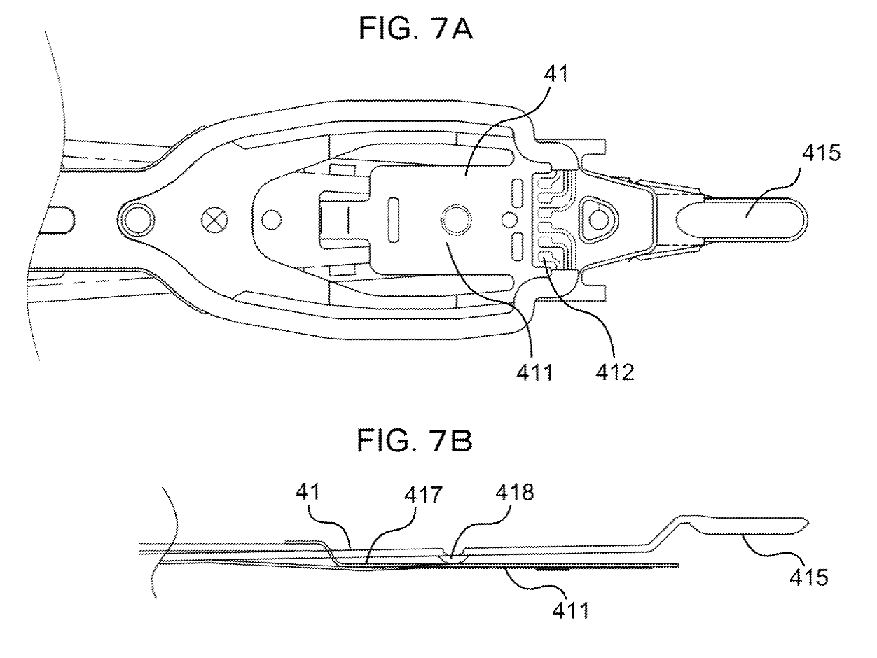

FIG. 7 illustrates the attachment surface for attaching the head slider. FIG. 7A illustrates the undersurface of the suspension 41. FIG. 7B is a side view of the suspension 41. The suspension 41 illustrated in FIG. 7 has an attachment surface 411 for attaching the head slider 43; multiple terminals (a first terminal) 412; and a flexure 417. The multiple terminals 412 connect with the second ends of wires 42, and the first ends of the wires 42 connect with a signal processor, not shown in the accompanied drawings, incorporated in the magnetic disk apparatus 31. The suspension 41 has a convex portion 418. The flexure 417 is supported by the suspension 41 at the convex 418. In this embodiment, the flexure 417 has the attachment surface 411 and the multiple terminals 412. The head slider 43 attached onto the tip of the suspension 41, that is the flexure 417, writes signals onto and read signals from the magnetic disk 35 rotated by a motor not shown in the accompanied drawings. The number of the suspensions 41 and the head sliders 43 attached on the magnetic head assembly 33 is not limited.

For convenience, the magnetic head assembly 33 herein is a load-unload type. Thus, the head slider 43 is loaded from a load-unload mechanism 34 to the magnetic disk 35 or unloaded from the magnetic disk 35 to the load-unload mechanism 34 in accordance with operations of the magnetic disk apparatus 31. As illustrated in FIG. 7, a load-unload tab 415 is provided on the tip of the suspension 41 of the magnetic head assembly 33, which is engageable with the load-unload mechanism 34. The load-unload tab 415 may be integrally formed with the suspension 41 for example. The load-unload tab 415 is guided along a guide of the load-unload mechanism 34 in loading and unloading. The head slider 43 is retracted into the load-unload mechanism 34 to prevent contact with a recording surface of the magnetic disk 35.

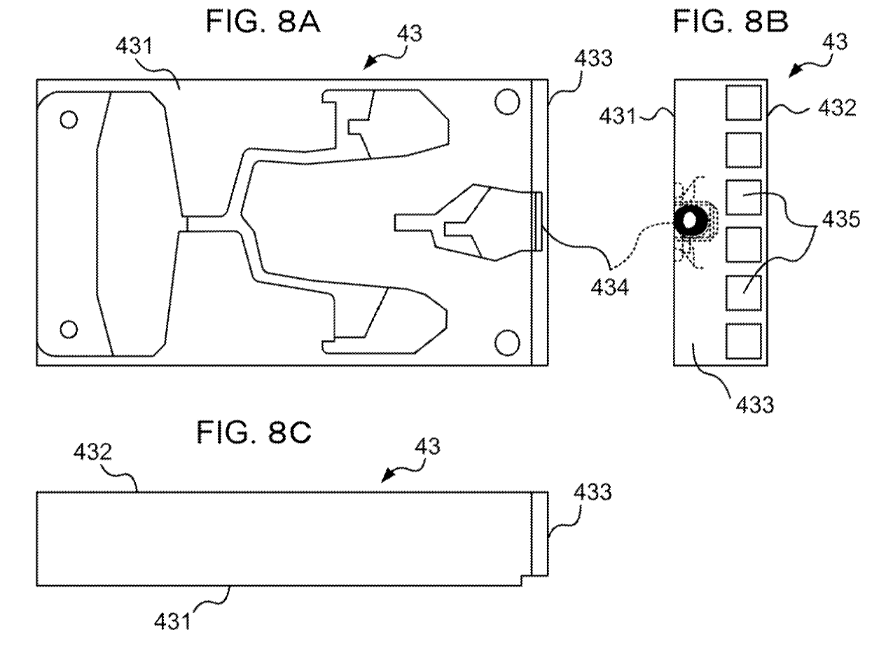

FIG. 8 illustrates the head slider 43 from three views. FIG. 8A illustrates the under surface of the head slider 43. FIG. 8B is a front view of the head slider 43. FIG. 8C is a side view of the head slider 43. When the head slider 43 tracks the magnetic disk 35 from, for example, 10 nm above the recording surface of the magnetic disk 35, air flows in from the left side of the head slider 43 and flows out from the right side of the head slider 43. As illustrated in FIG. 8, the head slider 43 has a tracking surface ABS 431, a fixed surface 432 formed on the opposite side of the ABS 431, a lateral side 433 that perpendicularly extends between the fixed surface 432 and the ABS 431, a head element 434 attached in the vicinity of the lateral side 433, and the multiple terminals (second terminals) 435, attached on the lateral side 433.

For the head slider 43 in the embodiments herein, three pairs of heaters not shown in the accompanied drawings are embedded. The flying height of the ABS 431 of the head slider 43 from the recording surface of the magnetic disk 35 is controlled via the heaters. The control mechanism of the flying height is known, and hence the description is omitted. There are six terminals 435 on the head slider 43 in total: two for signal writing, two for signal reading, and two for heater control. Of the two terminals for the heater control, one also serves as an earthing terminal. There are six correspondent terminals 412 on the suspension 41. The number of the terminals 412 and 435 are not fixed at six. When no heaters are embedded in the head slider 43, four terminals may be provided. When the heaters are embedded in the head slider 43, six or more terminals may be provided corresponding to the number of the heaters.

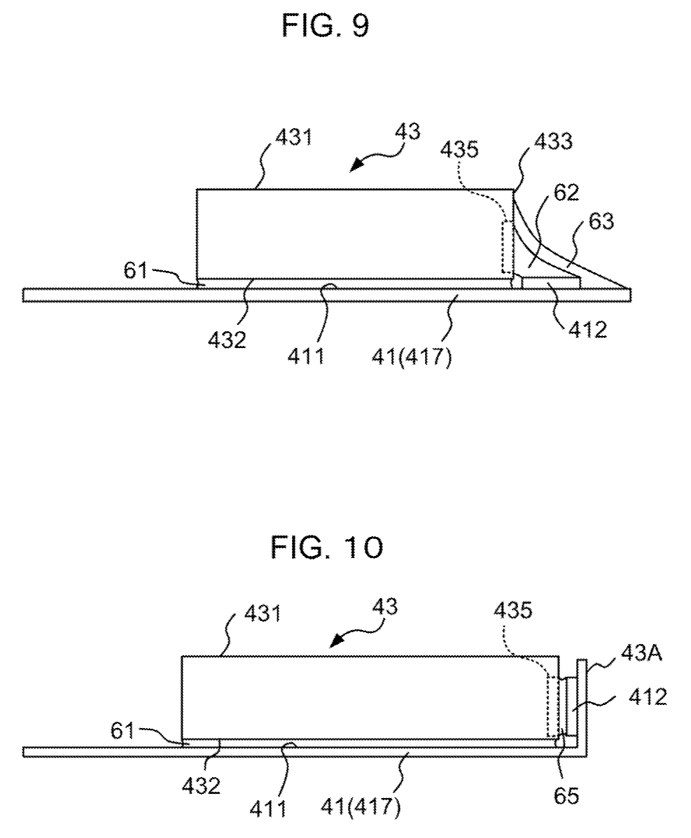

FIG. 9 is a side view illustrating a part of the magnetic head assembly according to the first embodiment of the present invention. As illustrated in FIG. 9, the fixed surface 432 of the head slider 43 is attached on the attachment surface 411 of the suspension 41, or flexure 417, with adhesive 61. The adhesive is not limited. For instance, conductive adhesives may be used. The terminals 435 attached on the head slider 43 are electrically connected to the correspondent terminals 412 attached on the suspension 41 with solder 62. The exposed surface of the solder 62 is covered with insulation 63. The insulation 63 is not limited. For instance, resin may be used. Preferably, the insulation 63 is made of a material having flexibility.

In this embodiment, the solder 62 is covered with the insulation 63 to prevent possible chip off by cracking attributed to stress, etc.

### Embodiment 2

FIG. 10 is a side view illustrating a portion of the magnetic head assembly according to the second embodiment of the present invention. As illustrated in FIG. 10, the portions that are common to the portions illustrated in FIG. 9 are given the same reference numbers and the descriptions are omitted. Through the embodiments 2 to 4 disclosed hereinafter, the structures of the suspension 41 including the flexure 417 are common to the structure in the first embodiment except in that the suspension 41, or the flexure 417, has a bent section 43A or 43B that perpendicularly extends from the attachment surface 432. Although there is the difference described above, it is considered unnecessary to illustrate and describe the overall structure of the HGA 37 and the like.

As illustrated in FIG. 10, the terminals 412 are attached on the bent section 43A of the suspension 41 with conductive material 65, opposing the correspondent terminals 435 attached on the head slider 43. The surfaces of the terminals 412 and 435 are generally parallel to each other. Therefore, the amount of the conductive material 65 used as solder may be reduced compared to the conventional art illustrated in FIG. 1. Additionally, since the terminals 412 and 435 are generally parallel and adjacent, the exposed area of the solder may be reduced significantly. Hence, the chip off of the solder may be reduced to a large degree in comparison with the conventional art illustrated in FIG. 1.

The conductive material 65 is not limited to the solder. There is another method to connect the terminals electrically. The conductive material 65 may be applied to either surface of the terminal 412 or 435 and then heat may be applied from the right side of the bent section 43A. The conductive material 65 may be coated over the surfaces of the terminals 412 and 435 with a known technique for printing. Alternatively, either of the terminals 412 or 435 may be made of gold and may connect with the correspondent terminals electrically by bonding such as thermocompression or ultrasonic bonding. With this technique, at least one of the terminals is melted and serves as the conductive material 65.

### Embodiment 3

FIG. 11 is a side view illustrating a portion of the magnetic head assembly according to the third embodiment of the present invention. As illustrated in FIG. 11, the portions that are common to the portions illustrated in FIG. 10 are given the same reference numbers and the descriptions of them are omitted.

As illustrated in FIG. 11, the terminals 412 attached on the suspension 41 extend over a portion of the attachment surface 411, and the terminals 435 attached on the head slider 43 extend over a portion of the fixed surface 432. With this structure, the opposed surfaces of the terminals 412 and 435 are increased compared to the second embodiment illustrated in FIG. 10. Therefore, the conductive material 65 is applied between the extended portions of the terminals 412 and 435, and a more secure electronic connection may be provided.

### Embodiment 4

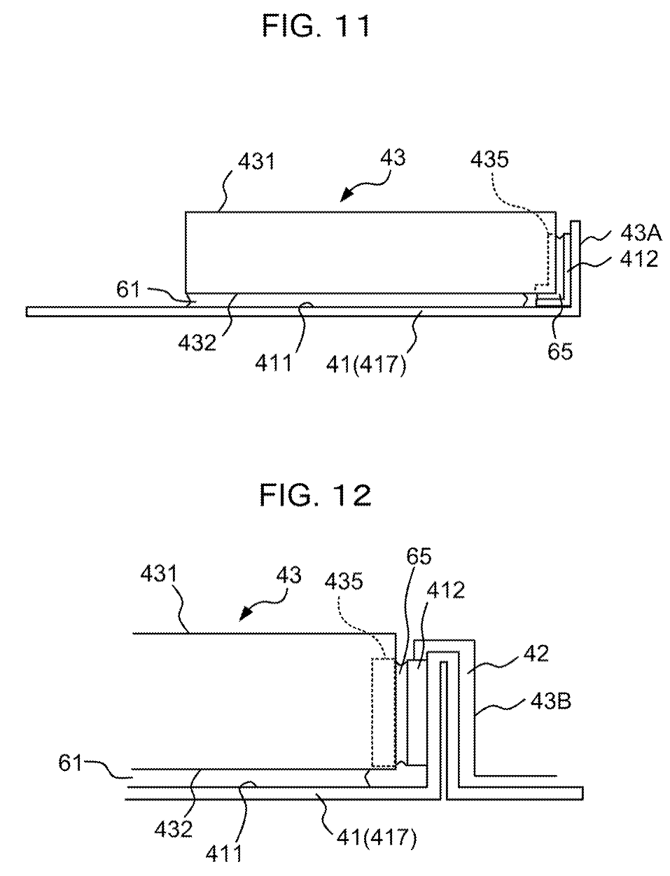

FIG. 12 is a side view illustrating a portion of the magnetic head assembly according to the fourth embodiment of the present invention. As illustrated in FIG. 12, the portions that are common to the portions illustrated in FIG. 10 are given the same reference numbers and the descriptions of them are omitted.

As illustrated in FIG. 12, the bent section 43B of the suspension 41 is in an inverted U-shape. The wires 42 are bent along the inverted U-shape of the bent section 43B. In other words, the wires 42 may be wired generally parallel with the attachment surface 411 of the suspension 41 even at the bent section 43B.

The magnetic disk apparatus having the structure according to each of the embodiments disclosed herein prevents the chip off of the conductive material materials such as solder for connecting the terminals attached on the head slider with the terminals attached on the suspension electrically. Therefore, the failures such as HDI of the magnetic disk apparatus attributed to the chip off of the conductive material may be reduced if not prevented, and the performance of the magnetic disk apparatus may be improved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A magnetic head assembly, comprising:
a suspension including an attachment surface, a bent section that extends generally vertically from the attachment surface, and a suspension comprising a first plurality of terminals provided on the bent section; and
a head slider including a tracking surface, a fixed surface provided on an opposite side of the tracking surface, a lateral side that extends generally perpendicularly from the fixed surface and connects the fixed surface and the tracking surface to each other, and a second plurality of terminals provided on the lateral side,
wherein the first plurality of terminals is opposed and connected electrically to the correspondent second plurality of terminals, with the fixed surface of the head slider fixed onto the attachment surface of the suspension.

2. The magnetic head assembly according to claim 1, wherein the first plurality of terminals extends over a portion of the attachment surface, and the second plurality of terminals extends over a portion of the fixed surface.

3. The magnetic head assembly according to claim 1, wherein a fixed surface of the head slider is fixed onto an attachment surface of the suspension with an adhesive.

4. The magnetic head assembly according to claim 1, wherein the first plurality of terminals is opposed and electrically connected to the correspondent second plurality of terminals with a conductive material.

5. The magnetic head assembly according to claim 4, wherein an exposed area of the conductive material is covered with insulation.

6. The magnetic head assembly according to claim 1, wherein the numbers of the first and second plurality of terminals are four or more, respectively.

7. A magnetic head assembly, comprising:
a suspension comprising an attachment surface and a first plurality of terminals provided on the attachment surface, and
a head slider comprising a tracking surface, a fixed surface provided on an opposite side of the tracking surface, a lateral side which extends generally perpendicularly from the fixed surface and connects the fixed surface and the tracking surface to each other, and a second plurality of terminals provided on the lateral side,
wherein the first plurality of terminals is opposed and electrically connected to the correspondent second plurality of terminals with solder, with the fixed surface of the head slider fixed onto the attachment surface of the suspension, and
wherein the solder is covered with insulation.

8. A storage apparatus, comprising:
a magnetic recording medium comprising a recording surface, and
a magnetic head assembly comprising a suspension and a head slider, wherein the suspension comprises an attachment surface, a bent section that extends generally perpendicularly from the attachment surface, and a first plurality of terminals provided on the bent section,
wherein the head slider comprises a tracking surface that flies over the recording surface of the magnetic recording medium when reading and writing signals, a fixed surface provided on an opposite side of the tracking surface, a lateral side that extends generally perpendicularly from the fixed surface and connects the fixed surface and the tracking surface to each other, and a second plurality of terminals provided on the lateral side,
wherein the first plurality of terminals is opposed and electrically connected to the correspondent second plurality of terminals, with the fixed surface of the head slider fixed onto the attachment surface of the suspension.

9. The storage apparatus according to claim 8, wherein the first plurality of terminals extends over a portion of the attachment surface, and the second plurality of terminals extends over a portion of the fixed surface.

10. The storage apparatus according to claim 8, wherein the first plurality of terminals is opposed and electrically connected to the correspondent second plurality of terminals with conductive material.

11. The storage apparatus according to claim 8, wherein the numbers of the first and second plurality of terminals are four or more.
